(19) United States
(12) Patent Application Publication
(10) Pub. No.: US 2010/0014862 A1
(43) Pub. Date: Jan. 21, 2010

(54) Mach-Zehnder Light Modulator, Mach-Zehnder Light Modulating Method, Optical Transmitter, Light Modulator, Optical Transmitting Apparatus, and Optical Receiving Apparatus

(76) Inventor: Akira Suzuki, Tokyo (JP)

Correspondence Address: Mr. Jackson Chen, 6535 N. STATE HWY 161, IRVING, TX, 75039, US

(21) Appl. No.: 12/438,202

(22) PCT Filed: May 11, 2007
(86) PCT No.: PCT/JP2007/059738

§ 371 Date: Feb. 20, 2009

(30) Foreign Application Priority Data
Aug. 21, 2006 (JP) 2006-224568

(51) Int. Cl. H04J 14/02

(52) U.S. Cl. 398/79

(57) ABSTRACT

A phase modulator (22) modulates, based on an electrical signal (Sa), the phase of one of optical signals of an input optical signal branched by a light branching circuit (21). Then, a phase modulator (23) performs phase modulation in a smaller amount and opposite polarity as compared to the phase modulator (22) based on an electrical signal (Sc) obtained by delaying the inverse logic signal (Sb) of the electrical signal (Sa) by a predetermined delay time τ shorter than the transient response time of the phase modulator (22) or the rise and fall times of the electrical signal (Sa). A light multiplexing circuit (24) multiplexes the optical signal obtained by the phase modulator (23) with the other optical signal of the input optical signal, thereby outputting a pulse-like output optical signal (36).

### TECHNICAL FIELD

The present invention relates to a fiber optics communication technique and, more particularly, to a technique of increasing the speeds and capacities of an optical transmitter and an optical communication apparatus.

### BACKGROUND ART

To deal with increases in traffic caused by, e.g., the spread of broadband connections and a variety of access means, a time multiplex transmission technique of transmitting optical signals multiplexed in the time domain or a wavelength multiplex transmission technique of transmitting optical signals multiplexed in the wavelength domain has been developed and put into practical use in a fiber optics transmission system.

For example, in the basic transmission system, a wavelength multiplex transmitting apparatus using 100 or more wavelengths and having a total transmission capacity of more than 1 Tbits/s has become practical. To further increase the transmission capacity, a technique of raising the bit rate per wavelength from 10 Gbits/s to 40 Gbits/s has been developed and is already well on its way to becoming practical. The capacity is increasing not only in the access system or basic transmission system but also for data transmission between apparatuses such as servers or between boards in an apparatus.

All these data transmissions require cost reduction of an optical communication apparatus in addition to downsizing and power consumption reduction.

In an optical communication apparatus, electronic circuits are responsible for a large share of its volume and power consumption. Recent electronic circuit components mainly use silicon semiconductors in place of compound semiconductors. Hence, optical devices for modulating light on the transmitting side or demodulating light on the receiving side also need to match the electronic circuits made of silicon semiconductors.

A light modulator is used for data transmission at a bit rate of more than 10 Gbits/s for each wavelength. Light modulators made of a compound semiconductor or lithium niobate have already been developed. However, these light modulators are expensive and bulky. New materials such as ceramics, silicon semiconductors, and ceramics on silicon substrates have recently received attention, and research and development of light modulators using these materials are progressing.

Since ceramics and silicon semiconductors are very common materials, and the microfabrication techniques for them are already ripe, inexpensive light modulators can be implemented. However, a ceramic has a very high dielectric constant. Short of using a depletion layer carrier, a silicon semiconductor has no refractive index control means because of its symmetrical crystal structure. Since the light modulator itself has an electrostatic capacitance due to these material characteristics, it is difficult to increase the transmission speed, and the bit rate is supposed to be limited to 10 Gbits/s to 20 Gbits/s.

Conventionally, techniques have been proposed which insert a phase modulator having a phase modulation amount 2π into one arm (optical waveguide) of a Mach-Zehnder light modulator connected to a laser source, thereby generating short pulses at the leading and trailing edges of the driving pulse of the phase modulator (e.g., Japanese Patent No. 3563027 and Japanese Patent Laid-Open Nos. 2003-21817, 2004-80462, and 2005-241902).

FIG. 13 is a block diagram showing a conventional Mach-Zehnder light modulator. In a Mach-Zehnder light modulator 9, a light branching circuit 92 branches an input optical signal 91 formed from a continuous laser beam into two arms. A phase modulator 93 is inserted into one arm. A light multiplexing circuit 94 multiplexes the optical signal from the phase modulator 93 with that from the other arm. The phase modulator 93 performs 2π phase modulation by applying a driving voltage from V₀ to V_{2π} based on an electrical signal 95 of RZ (Return to Zero) code. A pulse-like output optical signal 96 is obtained from the light multiplexing circuit 94 and time-multiplexed by bit interleaving.

### DISCLOSURE OF INVENTION

### Problem to be Solved by the Invention

An actual light modulator has only a finite response speed and no ideal response characteristic because the element itself has an electrostatic capacitance. However, the modulating method using the conventional Mach-Zehnder light modulator does not consider a transient response characteristic generated by the electrostatic capacitance of the light modulator. A measure against it is especially important because the method of generating short pulses by 2π phase modulation of one arm of the Mach-Zehnder light modulator is sensitive to the leading and trailing waveforms of the driving pulse and the transient response characteristic of the light modulator.

The waveform of the output optical pulse is determined by the rise and fall characteristics of the electrical signal and the transient response characteristic of the phase modulator. For this reason, according to the above-described related art, double pulses which are not completely separated are generated for the mark code of RZ code input as the electrical signal. When single pulses are extracted from the double pulses using the frequency chirp of the optical pulse, the pulse width of the optical pulse increases. If the optical pulse is directly time-multiplexed by bit interleaving, considerable intersymbol interference occurs. Hence, the method is not applicable to high-capacity high-speed transmission.

FIG. 14 is a timing chart of signal waveforms representing the phase modulating operation of the optical pulse generating apparatus in FIG. 13.

In general, a phase modulator for modulating the phase of an optical signal has a light modulation characteristic 97 represented by a sine function having a twofold period, as shown in FIG. 14. In the light modulation characteristic 97, when the driving voltage of the electrical signal 95 changes from V₀ corresponding to the zero phase modulation amount to V_{π} corresponding to a phase modulation amount π, the optical signal strength of the output optical signal 96 gradually increases and is maximized at V_{π}. After that, when the driving voltage changes from V_{π} to V_{2π} corresponding to the phase modulation amount 2π, the optical signal strength of the output optical signal 96 gradually decreases and is minimized at V_{2π}.

To obtain an optical pulse signal four times the bit rate of the electrical signal 95 in the phase modulator having the light modulation characteristic 97, it is necessary to implement steep rise and fall response characteristics equal to or less than ⅛ the code interval in the whole apparatus including the electric circuits and the light modulator. To do this, the band of the whole apparatus including the electric circuits and the light modulator must be four times or more of the bit rate.

However, if the band is fourfold, the bit rate of the electrical signal itself can also be fourfold. It is therefore unnecessary to use the method disclosed in the related art.

From another viewpoint, if the band of the whole apparatus including the electric circuits and the light modulator has a band characteristic corresponding to the bit rate, and 2π phase modulation is performed in one arm of the Mach-Zehnder light modulator, the optical pulses output from the Mach-Zehnder light modulator are connected without breaks. Since considerable intersymbol interference occurs upon time multiplex by bit interleaving, this method is not usable for photoelectrical signal transmission.

The present invention has been made to solve the above-described problems, and an exemplary object of the present invention is to provide an optical transmitter and an optical communication apparatus, which can implement high-capacity high-speed optical signal transmission using a light modulator having not so high operation speed.

### Means of Solution to the Problems

In order to achieve the object, a Mach-Zehnder light modulator according to an exemplary aspect of the present invention includes a light branching circuit which branches an input optical signal into two optical signals, a first phase modulator which modulates a phase of one of the optical signals branched by the light branching circuit based on a first electrical signal, and outputs the optical signal, a second phase modulator which modulates the phase of the optical signal from the first phase modulator in a smaller amount and opposite polarity as compared to the first phase modulator based on a second electrical signal obtained by delaying an inverse logic signal of the first electrical signal by a predetermined delay time shorter than a transient response time of the first phase modulator or rise and fall times of the first electrical signal, and outputs the optical signal, and a light multiplexing circuit which multiplexes the other optical signal branched by the light branching circuit with the optical signal from the second phase modulator, and outputs a pulse-like output optical signal.

A Mach-Zehnder light modulating method according to another exemplary aspect of the present invention includes performing, for one of two optical signals obtained by branching an input optical signal, first phase modulation based on a first electrical signal, performing second phase modulation based on a second electrical signal in a smaller amount and opposite polarity as compared to the first phase modulation, and multiplexing the optical signal obtained by the second phase modulation with the other optical signal of the continuous optical signal to output a pulse-like output optical signal, wherein the second electrical signal is an electrical signal obtained by delaying an inverse logic signal of the first electrical signal by a predetermined delay time shorter than a transient response time of the first phase modulation or rise and fall times of the first electrical signal.

An optical transmitter according to still another exemplary aspect of the present invention includes a laser source which outputs a continuous optical signal, the Mach-Zehnder light modulator described above (claim 1) which receives the continuous optical signal as an input optical signal, an electrical delay circuit which delays an inverse logic signal of an electrical signal to be input to the Mach-Zehnder light modulator by a predetermined delay time shorter than a transient response time of a first phase modulator in the Mach-Zehnder light modulator or rise and fall times of the electrical signal, thereby outputting a second electrical signal to be input to the Mach-Zehnder light modulator, and an optical filter which extracts one sideband component of an output optical signal from the Mach-Zehnder light modulator.

A light modulator according to still another exemplary aspect of the present invention includes the Mach-Zehnder light modulator described above (claim 1) which time-demultiplexes, based on a first electrical signal formed from a clock signal synchronized with a desired time channel, an optical pulse of a desired time channel from an input optical signal in which a plurality of time channels are multiplexed, and outputs the optical pulse, and an electrical delay circuit which delays an inverse logic signal of the first electrical signal by a predetermined delay time shorter than a transient response time of a first phase modulator in the Mach-Zehnder light modulator or rise and fall times of the first electrical signal, thereby outputting a second electrical signal to be input to the Mach-Zehnder light modulator.

An optical transmitting apparatus according to still another exemplary aspect of the present invention includes a laser source which outputs a continuous optical signal, a light branching circuit which branches the continuous optical signal into 2×m (m is a positive number) communication channels in which m time channels and two frequency channels are multiplexed, the Mach-Zehnder light modulators described above (claim 1) which are provided for the respective communication channels and modulate phases of optical signals from the light branching circuit based on electrical signals, light delay circuits which are provided for the respective communication channels and delay output optical signals from the Mach-Zehnder light modulators of the communication channels by times corresponding to the time channels of the communication channels, respectively, a first light multiplexing circuit which is provided in correspondence with one frequency channel and multiplexes output optical signals from the light delay circuits of m communication channels belonging to the frequency channel, a second light multiplexing circuit which is provided in correspondence with the other frequency channel and multiplexes output optical signals from the light delay circuits of m communication channels belonging to the frequency channel, a first optical filter which extracts a sideband component on a high frequency side of an output optical signal from the first light multiplexing circuit, a second optical filter which extracts a sideband component on a low frequency side of an output optical signal from the second light multiplexing circuit, and a light multiplexing circuit which multiplexes output optical signals from the first optical filter and the second optical filter.

An optical transmitting apparatus according to still another exemplary aspect of the present invention include a laser source which outputs a continuous optical signal, a light branching circuit which branches the continuous optical signal into 2×m (m is a positive number) communication channels in which m time channels and two frequency channels are multiplexed, the Mach-Zehnder light modulators described above (claim 1) which are provided for the respective communication channels and modulate phases of optical signals from the light branching circuit based on electrical signals, light delay circuits which are provided for the respective communication channels and delay output optical signals from the Mach-Zehnder light modulators of the communication channels by times corresponding to the time channels of the communication channels, respectively, first optical filters which are provided for m communication channels belonging to one frequency channel, respectively, and extract sideband components on a high frequency side of output optical signals from the light delay circuits of the communication channels, second optical filters which are provided for m communication channels belonging to the other frequency channel, respectively, and extract sideband components on a low frequency side of output optical signals from the light delay circuits of the communication channels, a first light multiplexing circuit which is provided in correspondence with one frequency channel and multiplexes output optical signals from m first optical filters belonging to the frequency channel, a second light multiplexing circuit which is provided in correspondence with the other frequency channel and multiplexes output optical signals from m second optical filters belonging to the frequency channel, and a light multiplexing circuit which multiplexes output optical signals from the first light multiplexing circuit and the second light multiplexing circuit.

An optical receiving apparatus according to still another exemplary aspect of the present invention includes a light branching circuit which branches, into frequency channels, a received optical signal containing 2×m (m is a positive number) communication channels in which m time channels and two frequency channels are multiplexed, a first optical filter which is provided in correspondence with one frequency channel and extracts a sideband component on a high frequency side of an optical signal from the light branching circuit, a second optical filter which is provided in correspondence with the other frequency channel and extracts a sideband component on a low frequency side of an optical signal from the light branching circuit, the Mach-Zehnder light modulators described above (claim 6) each of which demultiplexes an output optical signal containing a pulse at a time position corresponding to the communication channel, and time demultiplex switches each of which demultiplexes an output optical signal corresponding to the communication channel from the time position corresponding to the communication channel of an output optical signal from a corresponding one of the Mach-Zehnder light modulators, and outputs the output optical signal.

An optical receiving apparatus according to still another exemplary aspect of the present invention includes a light branching circuit which branches, into frequency channels, a received optical signal containing 2×m (m is a positive number) communication channels in which m time channels and two frequency channels are multiplexed, a first optical filter which is provided in correspondence with one frequency channel and extracts a sideband component on a high frequency side of an optical signal from the light branching circuit, a second optical filter which is provided in correspondence with the other frequency channel and extracts a sideband component on a low frequency side of an optical signal from the light branching circuit, and the Mach-Zehnder light modulators described above (claim 6) which demultiplex output optical signals containing optical pulses of the communication channels from time positions corresponding to two communication channels, and outputs the output optical signals.

### Effects of the Invention

According to the Mach-Zehnder light modulator and the Mach-Zehnder light modulating method of the present invention, it is possible to generate double pulses having a satisfactory waveform which compensates for the rise and fall characteristics of the electrical signal and the transient response characteristic of the phase modulators without any intersymbol interference and simultaneously generate a large frequency chirp using an existing light modulator having not so high operation speed.

This allows to set the frequency chirp amount of the output optical signal to a value larger than the Fourier transform value of the pulse width. It is therefore possible to generate a high-quality RZ code photoelectrical signal close to the Fourier transform limit using a simple arrangement including an optical filter, and implement high-capacity high-speed photoelectrical signal transmission free from intersymbol interference.

According to the light modulator of the present invention, it is possible to apply even a phase modulator whose band is greatly short with respect to the bit rate, and obtain a satisfactory modulation waveform and frequency chirp characteristic by compensating for the band characteristic.

According to the light modulator of the present invention, it is possible to time-demultiplex, from a desired time position, an optical pulse having a satisfactory waveform which compensates for the rise and fall characteristics of the electrical signal and the transient response characteristic of the phase modulators without any intersymbol interference using an existing light modulator having not so high operation speed. This allows to time-demultiplex the optical pulse of an arbitrary time channel from a high-capacity high-speed photoelectrical signal that is bit-interleaved at a high rate.

According to the optical transmitting apparatus or optical receiving apparatus of the present invention, it is possible to implement high-capacity high-speed transmission at 200 Gbits/s using one light source having one wavelength by combining time multiplex of four channels and frequency multiplex of two channels even when the band of a phase modulator is 25 GHz. It is also possible to suppress the penalty of the receiving level caused by intersymbol interference and beat noise generated upon multiplex to about 1 to 2 dB.

### BRIEF DESCRIPTION OF DRAWINGS

FIG. 1 is a block diagram showing the arrangement of an optical transmitter according to the first exemplary embodiment of the present invention;

FIG. 2 is a timing chart of signal waveforms representing the principle of a phase modulating method according to the present invention;

FIG. 3 is a timing chart of signal waveforms representing the principle of a phase modulating operation according to the present invention;

FIG. 4 is a timing chart of signal waveforms representing the operation of a conventional optical transmitter corresponding to the first exemplary embodiment of the present invention;

FIG. 5 is a timing chart of signal waveforms representing the operation of the optical transmitter according to the first exemplary embodiment of the present invention;

FIG. 6 is a timing chart of signal waveforms representing the operation of a conventional optical transmitter corresponding to the second exemplary embodiment of the present invention;

FIG. 7 is a timing chart of signal waveforms representing the operation of an optical transmitter according to the second exemplary embodiment of the present invention;

FIG. 8 is a block diagram showing the arrangement of a light modulator according to the third exemplary embodiment of the present invention;

FIG. 9 is a block diagram showing the arrangement of an optical transmitting apparatus according to the fourth exemplary embodiment of the present invention;

FIG. 10 is a block diagram showing the arrangement of another optical transmitting apparatus according to the fourth exemplary embodiment of the present invention;

FIG. 11 is a block diagram showing the arrangement of an optical receiving apparatus according to the fifth exemplary embodiment of the present invention;

FIG. 12 is a block diagram showing the arrangement of another optical receiving apparatus according to the fifth exemplary embodiment of the present invention;

FIG. 13 is a block diagram showing a conventional Mach-Zehnder light modulator; and

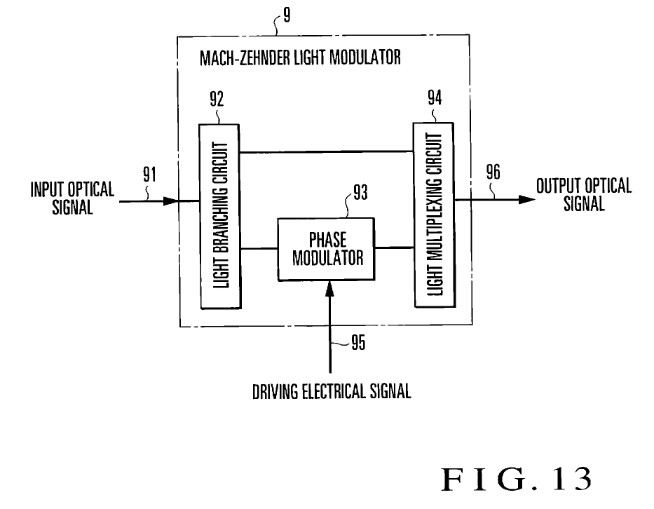

FIG. 14 is a timing chart of signal waveforms representing the phase modulating operation of the optical pulse generating apparatus in FIG. 13.

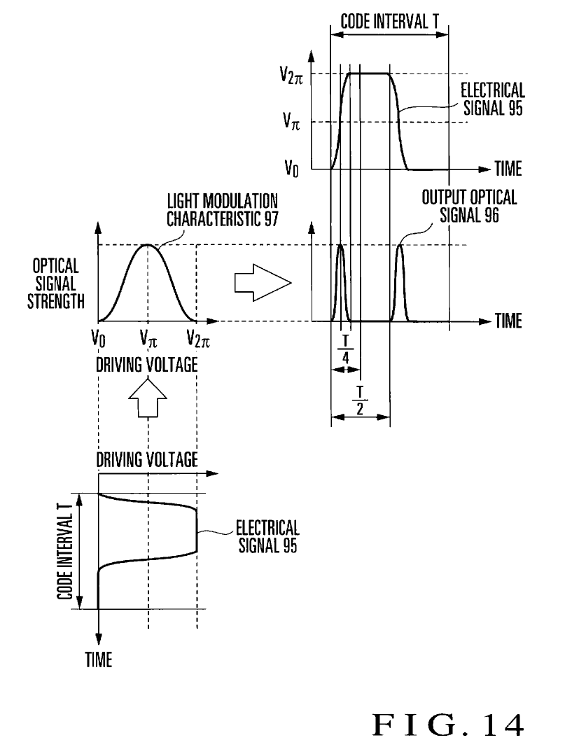

### BEST MODE FOR CARRYING OUT THE INVENTION

The exemplary embodiments of the present invention will now be described with reference to the accompanying drawings.

### First Exemplary Embodiment

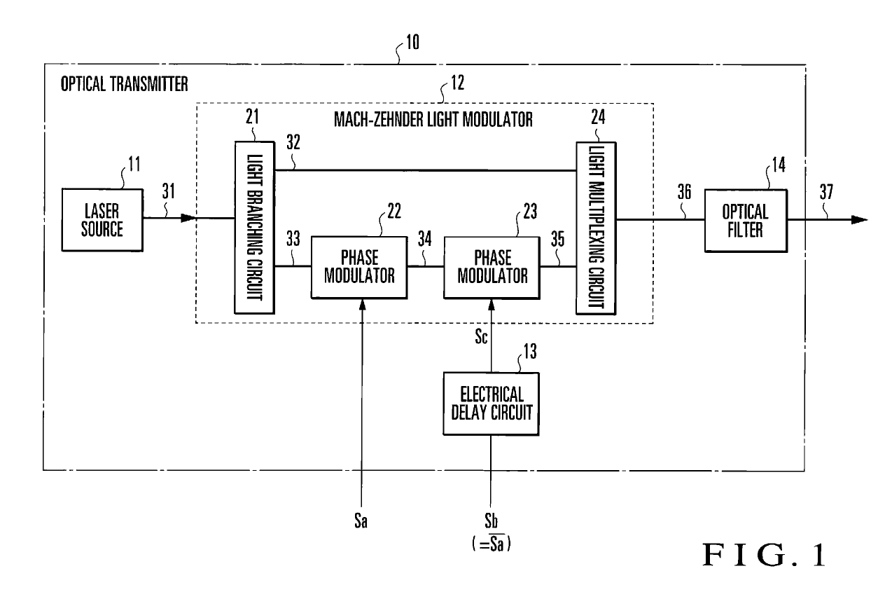

An optical transmitter according to the first exemplary embodiment of the present invention will be described first with reference to FIG. 1. FIG. 1 is a block diagram showing the arrangement of the optical transmitter according to the first exemplary embodiment of the present invention. An optical transmitter 10 is a communication apparatus which modulates the phase of an input optical signal formed from a continuous laser beam using an electrical signal and outputs an optical pulse output signal. The optical transmitter 10 includes a laser source 11, Mach-Zehnder light modulator 12, electrical delay circuit 13, and optical filter 14.

The laser source 11 includes a laser beam generating circuit, and has a function of outputting a generated continuous laser beam as an input optical signal 31.

The Mach-Zehnder light modulator 12 includes a light modulating circuit using, e.g., an electrooptic effect, and has a function of modulating the strength and phase of the input optical signal 31 from the laser source 11 by a Mach-Zehnder light modulating method using an electrical signal and outputting a pulse-like output optical signal 36.

The electrical delay circuit 13 includes a common delay circuit, and has a function of delaying an inverse logic signal Sb of an electrical signal (first electrical signal) Sa by a delay time τ and outputting it as an electrical signal (second electrical signal) Sc. A time shorter than the transient response time of a phase modulator 22 in the Mach-Zehnder light modulator 12 (to be described later) or the rise and fall times of the electrical signal Sa is used as the delay time τ. Note that the inverse logic signal Sb which is synchronized with the electrical signal Sa and has an opposite logic can be obtained using, e.g., a differential output logic circuit.

The optical filter 14 includes an optical filter circuit having a bandpass transmission characteristic approximated by a linear Gaussian function, and has a function of passing only the signal component of one sideband of the output optical signal 36 output from the Mach-Zehnder light modulator 12 and outputting an output optical signal 37. The center frequency of the optical filter 14 shifts from the frequency of the laser source 11 to the high frequency side by a predetermined frequency. The bandwidth of the optical filter 14 is larger than the Fourier transform value of the optical pulse width of RZ code.

The Mach-Zehnder light modulator 12 includes a light branching circuit 21, phase modulator (first phase modulator) 22, phase modulator (second phase modulator) 23, and light multiplexing circuit 24.

The light branching circuit 21 includes optical waveguides and bulk circuit components, and has a function of branching the input optical signal 31 into two input optical signals 32 and 33 and outputting them from different arms (optical waveguides).

The light multiplexing circuit 24 includes optical waveguides and bulk circuit components, and has a function of multiplexing the input optical signal 32 from the light branching circuit 21 with an optical signal 35 from the phase modulator 23 and outputting the output optical signal 36.

The phase modulator 22 is connected to one arm of the light branching circuit 21, and has a function of modulating the phase of the input optical signal 33 from the light branching circuit 21 by φ+Δθ by applying a driving voltage from V₀ to V_{φ+Δθ} based on the electrical signal (first electrical signal) Sa of RZ (Return to Zero) code, which serves as a driving electrical signal, and outputting an optical signal 34. V₀ is the driving voltage which minimizes the optical output from the Mach-Zehnder light modulator, and φ is the phase modulation amount given to the input optical signal 33. An example will be explained below, in which a driving voltage at which the optical output is zero is used as V₀ to obtain a maximum light modulation factor for the input optical signal 33, and 2π is used as a phase modulation amount φ. However, the present invention is not limited to this, and the values V₀ and φ are selected in accordance with the desired optical signal strength or light intensity. Δθ (>0) is a phase compensation amount to compensate for the transient response time of the phase modulator 22 or the rise and fall times of the electrical signal Sa.

The phase modulator 23 is connected to the output of the phase modulator 22, and has a function of modulating the phase of the optical signal 34 from the phase modulator 22 by −Δθ (<0) by applying a driving voltage from V₀ to V_{-Δθ} based on the electrical signal (second electrical signal) Sc from the electrical delay circuit 13, which serves as a driving electrical signal, and outputting the optical signal 35. A phase modulation amount −Δθ given by the phase modulator 23 is smaller than the phase modulation amount φ+Δθ given by the phase modulator 22 and has an opposite sign. Hence, φ and Δθ are set such that the average of the phase modulation amount given by the phase modulator 22 and that given by the phase modulator 23 equals a phase modulation amount to obtain a desired light modulation factor or light intensity in the output optical signal 36.

[Principle of Phase Modulating Method of Present Invention]

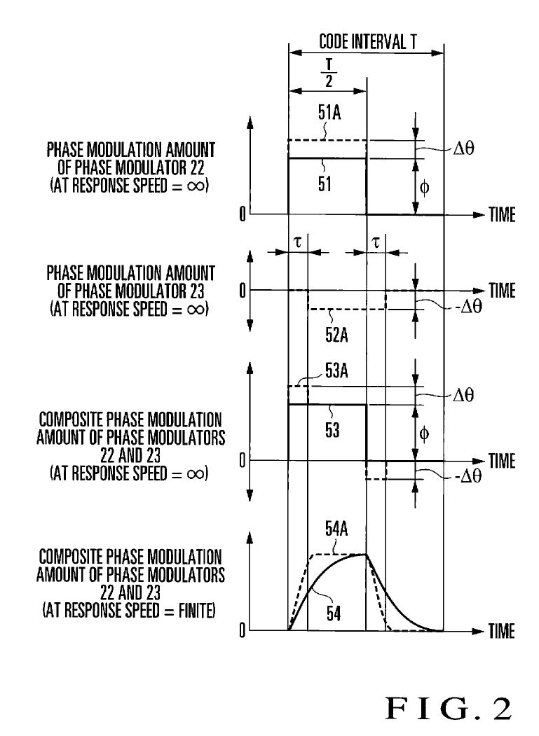

The principle of the phase modulating method of the present invention will be described next with reference to FIG. 2.

FIG. 2 is a timing chart of signal waveforms representing the principle of the phase modulating method according to the present invention. Referring to FIG. 2, waveforms 51, 51A, 52A, 53, and 53A represent changes in the phase modulation amount when the rise and fall times of the electrical signal are zero, and the response speed of each phase modulator is infinite. Waveforms 54 and 54A represent changes in the phase modulation amount when the rise and fall times of the electrical signal and the response speed of each phase modulator are finite (actual circuit).

The principle of the phase modulating method of the present invention is based on a phenomenon that the phase modulation waveform in the actual circuit steeply changes when the phase modulation amount is made larger than the phase modulation amount φ corresponding to the desired light intensity of the output optical signal pulse by Δθ during the transient period of the electrical signal waveform for driving the phase modulator.

As shown in FIG. 2, the conventional phase modulating method corresponds to a case in which the phase modulator 22 modulates the phase by only φ, and the phase modulation amount of the phase modulator 23 is zero, as indicated by the waveform 51. For this reason, the composite phase modulation amount of the phase modulators 22 and 23 equals the waveform 51, as indicated by the waveform 53. Hence, the composite phase modulation amount of the phase modulators 22 and 23 in the actual circuit delays due to the transient response time of the phase modulator 22 and the rise and fall times of the electrical signal Sa so that the rise and fall characteristics become moderate, as indicated by the waveform 54.

On the other hand, in the phase modulating method of the present invention, the phase modulator 22 uses the phase modulation amount φ+Δθ, as indicated by the waveform 51A, and the phase modulator 23 uses the phase modulation amount −Δθ, as indicated by the waveform 52A. The phase modulator 23 starts phase modulation with a lag of the delay time τ behind the phase modulator 22.

Hence, the composite phase modulation amount of the phase modulators 22 and 23, i.e., the phase difference between the two arms of the Mach-Zehnder light modulator 12 is represented by the waveform 53A obtained by compositing the waveforms 51A and 52A. Hence, the phase modulation amount is larger by Δθ in the period of the delay time τ from the leading or trailing edge of the waveform 53A.

With this arrangement, even when the length of the transient period of the electrical signal waveform is the same as in the related art, phase modulation larger than before is applied during the transient period. Hence, the composite phase modulation amount of the phase modulators 22 and 23 in the actual circuit has steep rise and fall characteristics, as indicated by the waveform 54A.

This makes it possible to compensate for degradation in the waveform caused by the rise and fall characteristics of the electrical signal or the transient response characteristic of the phase modulators.

In the first exemplary embodiment of the present invention, a detailed example of the arrangement for applying larger phase modulation during the transient period has been described, in which the phase modulators 22 and 23 are provided in series in one arm of the Mach-Zehnder light modulator. The phase modulator 23 performs phase modulation in a smaller amount and opposite polarity as compared to the phase modulator 22 with a lag of the delay time τ behind the phase modulator 22, thereby compositing the two phase modulations. However, any other arrangement is applicable if it can implement the above-described principle. For example, the principle may be implemented using three or more phase modulators.

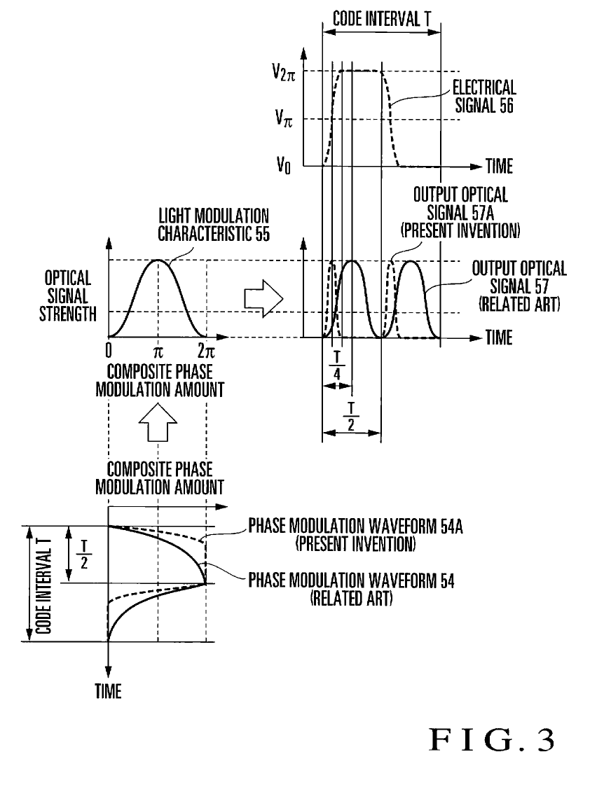

FIG. 3 is a timing chart of signal waveforms representing the principle of a phase modulating operation according to the present invention.

Generally, a phase modulator for modulating the phase of an optical signal has a light modulation characteristic 55 represented by a sine function having a twofold period, as shown in FIG. 3. In the light modulation characteristic 55, when the phase modulation amount changes from zero to π, the optical signal strength gradually increases and is maximized at π. After that, when the phase modulation amount changes from π to 2π, the optical signal strength gradually decreases and is minimized at 2π.

When the phase modulator having the light modulation characteristic 55 modulates the phase by the conventional phase modulation waveform 54 corresponding to an electrical signal 56, the optical pulse width of an obtained output optical signal 57 is large because the leading and trailing waveforms of the phase modulation waveform 54 are moderate. For example, when the transient period of the phase modulation waveform 54 is about ½ a code interval T, i.e., T/2, the optical pulse width of the obtained output optical signal 57 also increases to T/2.

To the contrary, if phase modulation is performed using the above-described phase modulation waveform 54A of the present invention, the optical pulse width of the obtained output optical signal 57 is small even when the same electrical signal 56 as in the related art is used because the leading and trailing waveforms of the phase modulation waveform 54A are steep. For example, when the transient period of the phase modulation waveform 54A is T/4 or less, the optical pulse width of the obtained output optical signal 57 is also T/4 or less. Hence, even when time multiplex is performed by bit interleaving, high-capacity high-speed optical signal transmission free from intersymbol interference can be implemented using an existing light modulator having not so high operation speed.

[Operation of First Exemplary Embodiment]

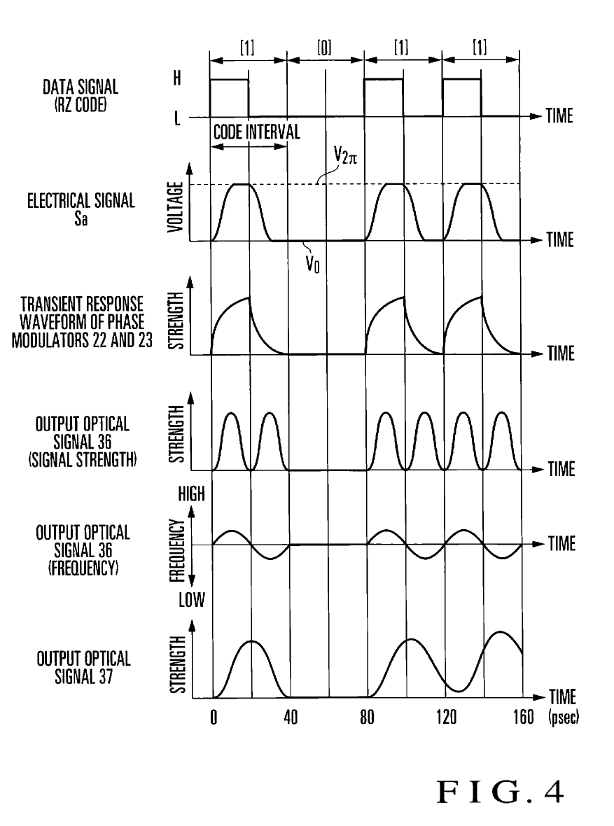

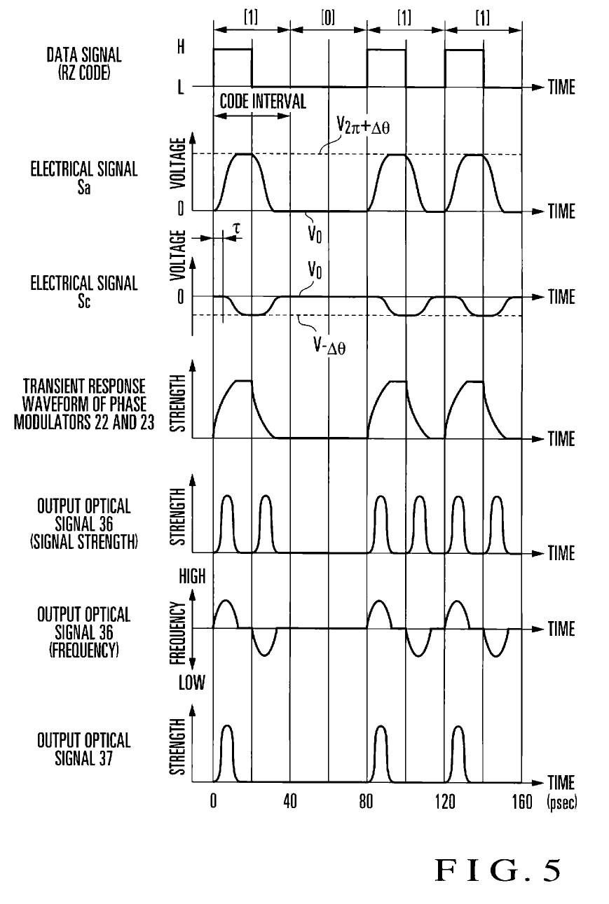

The operation of the optical transmitter according to the first exemplary embodiment of the present invention will be described next with reference to FIGS. 4 and 5. FIG. 4 is a timing chart of signal waveforms representing the operation of a conventional optical transmitter. FIG. 5 is a timing chart of signal waveforms representing the operation of the optical transmitter according to the first exemplary embodiment of the present invention.

An example will be explained here in which the bit rate of the electrical signals Sa and Sc is 25 Gbits/s. Note that the electric circuit for generating the electrical signals Sa and Sc corresponds to RZ code, and has rise and fall response characteristics ⅓ the code interval, like a normal RZ electrical signal circuit. The band determined by the electrostatic capacitance of the phase modulators 22 and 23 is 25 GHz corresponding to the bit rate.

The light branching circuit 21 in the Mach-Zehnder light modulator 12 branches the input optical signal 31 from the laser source 11 into the two input optical signals 32 and 33. The input optical signal 33 is input to the phase modulator 22. The phase modulator 22 modulates the phase by φ+Δθ using the electrical signal Sa of RZ code as a driving electrical signal and outputs the optical signal 34. The optical signal 34 is input to the phase modulator 23. The phase modulator 23 modulates the phase by −Δθ using the electrical signal Sc of RZ code generated by the electrical delay circuit 13 as a driving electrical signal and outputs the optical signal 35.

The phase modulation amount given by the phase modulator 23 is smaller than that given by the phase modulator 22 and has an opposite sign. It is therefore possible to generate double pulses having a satisfactory waveform that compensates for the rise and fall characteristics of the electrical signals Sa and Sc and the transient response characteristic of the phase modulators, and also generate a large frequency chirp.

Then, the optical signal 35 and the input optical signal 32 are input to the light multiplexing circuit 24, multiplexed, and output as the output optical signal 36. The output optical signal 36 is input to the optical filter 14. The optical filter 14 passes only the signal component of one sideband of the output optical signal 36 and outputs the output optical signal 37.

[Conventional Phase Modulating Operation]

FIG. 4 shows the signal waveforms of the respective portions of the optical transmitter according to the related art, which are obtained when 2π phase modulation is performed using only the phase modulator 22 in FIG. 1. FIG. 4 shows the waveforms of the electrical signals Sa and Sc corresponding to an RZ electrical signal having a “1011” pattern, the transient response waveform of the optical signal 34 of the phase modulator 22 for the rectangular electrical pulse, the waveform of the output optical signal 36 from the Mach-Zehnder light modulator 12, the frequency of the output optical signal 36 from the Mach-Zehnder light modulator 12, and the waveform of the output optical signal 37 from the optical filter 14.

These waveforms and frequency characteristics are obtained by analyzing the arrangement of the optical transmitter (FIG. 1) according to this exemplary embodiment using fast Fourier transform in consideration of the RZ code, the electrical signal waveforms, and the electrostatic capacitance of the phase modulators.

The optical filter 14 has a bandpass transmission characteristic approximated by a linear Gaussian function. The center frequency of the optical filter 14 shifts from the frequency of the laser source 11 to the high frequency side by 100 GHz. The bandwidth of the optical filter 14 is 100 GHz, which is larger than the Fourier transform value of the optical pulse width of RZ code.

As is apparent from the frequency characteristic of the output optical signal 36 from the Mach-Zehnder light modulator 12 in FIG. 4, the double optical pulses output from the Mach-Zehnder light modulator 12 chirp in opposite directions, i.e., to the high frequency side and low frequency side. Using this fact, the double optical pulses are separated by extracting the sideband component on the high frequency side from the chirped output optical signal 36 from the Mach-Zehnder light modulator 12 using the optical filter 14. This enables time multiplex by bit interleaving.

As shown in FIG. 4, the waveforms of the electrical signals Sa and Sc and the response characteristic of the phase modulator 22 have sufficient bands with respect to the signal of 25 Gbits/s. Additionally, as can be seen from the waveform of the output optical signal 36, a short optical pulse signal is apparently generated.

However, when single pulses are extracted from the double optical pulses using the optical filter 14, the pulse width of the optical pulse increases, as is apparent from the waveform of the output optical signal 37 from the optical filter 14 in FIG. 4.

To cause the optical filter 14 to generate single pulses from the double optical pulses, a predetermined frequency chirp corresponding to the spectral bandwidth equal to or more than the Fourier transform value of the pulse width is necessary. Assume that the pulse width of the optical pulse to be generated by the optical filter 14 is 10 psec (picoseconds). In this case, the frequency chirp amount necessary for generating the pulse is calculated as 44 GHz based on the Fourier transform limit assuming an ideal Gaussian function waveform. Since the actual waveform shifts from the Gaussian function, a larger frequency chirp is necessary.

In the example shown in FIG. 4, when the phase modulator 22 performs 2π phase modulation, the phase modulation amount of the output optical signal 36 from the Mach-Zehnder light modulator 12 is π. Hence, the frequency chirp given by temporal differentiation is 25 GHz. Even when the ideal Gaussian waveform is assumed, the spectral bandwidth corresponding to the frequency chirp is short, and the optical pulse obtained by cutting one sideband component by the optical filter 14 has a large pulse width. As is apparent from the waveform of the output optical signal 37 from the optical filter 14 in FIG. 4, the optical signal having a large pulse width causes intersymbol interference upon time multiplex. It is therefore difficult to implement high-capacity high-speed optical signal transmission.

[Phase Modulating Operation of this Exemplary Embodiment]

To solve this problem, it is necessary to generate double pulses having a satisfactory waveform as the output optical signal from the Mach-Zehnder light modulator 12 and simultaneously generate a sufficient frequency chirp.

In this exemplary embodiment, the phase modulator 22 inserted into one arm of the Mach-Zehnder light modulator 12 is driven at a voltage amplitude larger than that of the voltage for 2π phase modulation to perform phase modulation, and after that, the phase modulator 23 performs phase modulation of a sign opposite to that of the phase modulator 22, as shown in FIG. 1.

This makes it possible to generate double pulses having a satisfactory waveform which compensates for the rise and fall characteristics of the electrical signal and the transient response characteristic of the phase modulators and simultaneously generate a large frequency chirp. It is therefore possible to generate a high-quality RZ code photoelectrical signal close to the Fourier transform limit using a simple arrangement including an optical filter based on the large frequency chirp, and implement high-capacity high-speed photoelectrical signal transmission free from intersymbol interference.

FIG. 5 shows the signal waveforms of the respective portions of the optical transmitter according to this exemplary embodiment, which are obtained when the phase modulation amount Δθ is π/3, and the delay time τ is 14 psec. FIG. 5 shows the waveforms of the electrical signals Sa and Sc corresponding to an RZ electrical signal having a “1011” pattern, the transient response waveform of the optical signal 35 of the entire phase modulators 22 and 23 for the driving electrical pulse, the waveform of the output optical signal 36 from the Mach-Zehnder light modulator 12, the frequency of the output optical signal 36 from the Mach-Zehnder light modulator 12, and the waveform of the output optical signal 37 from the optical filter 14. Note that the delay time of 14 psec is the transient response time of the phase modulator 22 for the rectangular electrical pulse.

These waveforms and frequency characteristics are obtained by analyzing the arrangement of the optical transmitter (FIG. 1) according to this exemplary embodiment using fast Fourier transform in consideration of the RZ code, the electrical signal waveforms, and the response waveform of each phase modulator.

The phase modulation amount Δθ and the delay time τ are set to compensate for the transient response time of the phase modulators 22 and 23.

The phase modulation amount Δθ and the delay time τ can also be set to compensate for the rise and fall times of the electrical signals Sa and Sc. Alternatively, the phase modulator 23 is divided into a plurality of phase modulating units. The delay times τ of the respective phase modulating units with respect to the phase modulator 22 are set to different values within the range of time shorter than the transient response time of the phase modulator 22 or the rise and fall times of the electrical signal Sa, more optimum adjustment is possible.

In the optical transmitter according to this exemplary embodiment, if the phase modulation amount given by the phase modulator 22 is 7π/3 larger than 2π, the time during which the phase modulation amount reaches 2π in the transient response waveform of the optical signal 35 for the rectangular electrical pulse of the entire phase modulators 22 and 23 shortens to 11 psec, i.e., about ½ that of the related art. This doubles the frequency chirp given by the temporal differentiation of the phase modulation amount.

Phase modulation after the phase modulation amount has reached 2π is canceled by the phase modulation amount −π/3 given by the phase modulator 23 after the delay time of 14 psec and therefore has no influence on the output optical pulse waveform. This also applies to the trailing edge of the pulse.

In this exemplary embodiment, the delay time is set not to 11 psec but to 14 psec. This value is optimally designed by analysis using fast Fourier transform while strictly considering the fact that the driving pulse waveform is not completely rectangular but has rise and fall times.

As is apparent from the waveform and frequency characteristics of the output optical signal 36 from the Mach-Zehnder light modulator 12 shown in FIG. 5, the phase modulators 22 and 23 having a two-stage operation driving arrangement generate steep rise and fall characteristics, and the frequency chirp becomes large as the waveform improves.

More specifically, when the phase modulation amount Δθ and the delay time τ are optimized, double pulses having the same amplitude and opposite frequency chirp signs can be obtained as the output optical signal 36 from the Mach-Zehnder light modulator 12. Hence, the output optical signal 36 has a spectral bandwidth corresponding to a frequency chirp larger than the Fourier transform value of the optical pulse width.

As is apparent from the waveform of the output optical signal 37 from the optical filter 14 in FIG. 5, even when the optical filter 14 cuts one sideband component of the output optical signal 36, an increase in the pulse width is suppressed, and an optical signal capable of time multiplex by bit interleaving can be obtained.

As described above, in the Mach-Zehnder light modulator 12 according to this exemplary embodiment, the light branching circuit 21 branches the input optical signal 31 into two optical signals. The phase modulator (first phase modulator) 22 modulates the phase of one of the optical signals based on the electrical signal (first electrical signal) Sa. Then, the phase modulator (second phase modulator) 23 performs phase modulation in a smaller amount and opposite polarity as compared to the phase modulator 22 based on the electrical signal (second electrical signal) Sc obtained by delaying the inverse logic signal Sb of the electrical signal Sa by the predetermined delay time τ shorter than the transient response time of the phase modulator 22 or the rise and fall times of the electrical signal Sa. The light multiplexing circuit 24 multiplexes the optical signal obtained by the phase modulator 23 with the other optical signal of the input optical signal and outputs the pulse-like output optical signal 36.

The optical transmitter according to this exemplary embodiment includes the laser source 11 which outputs a continuous optical signal, the Mach-Zehnder light modulator 12 which receives the continuous optical signal as the input optical signal, the electrical delay circuit 13 which outputs the electrical signal Sc based on the electrical signal Sa to be input to the Mach-Zehnder light modulator 12, and the optical filter 14 which extracts one sideband component of the output optical signal from the Mach-Zehnder light modulator 12.

It is therefore possible to generate double pulses having a satisfactory waveform which compensates for the rise and fall characteristics of the electrical signal and the transient response characteristic of the phase modulators without any intersymbol interference and simultaneously generate a large frequency chirp using an existing light modulator having not so high operation speed.

This allows to set the frequency chirp amount of the output optical signal to a value larger than the Fourier transform value of the pulse width. It is therefore possible to generate a high-quality RZ code photoelectrical signal close to the Fourier transform limit using a simple arrangement including an optical filter, and implement high-capacity high-speed photoelectrical signal transmission free from intersymbol interference.

In the Mach-Zehnder light modulator 12, the average of the phase modulation amounts of the phase modulators 22 and 23 may equal a phase modulation amount to obtain a desired light intensity in the output optical signal 36. For example, when the average of the phase modulation amounts of the phase modulators 22 and 23 is set to π, the output optical signal 36 which always maximizes the light intensity independently of the value of the phase modulation amount Δθ can be obtained.

In the Mach-Zehnder light modulator 12, the sum of the phase modulation amount 2π to obtain a desired light modulation factor in the output optical signal 36 and the predetermined phase modulation amount Δθ to compensate for the transient response time of the phase modulator 22 or the rise and fall times of the electrical signal Sa may be used as the phase modulation amount of the phase modulator 22, and the phase modulation amount −Δθ may be used as the phase modulation amount of the phase modulator 23. For example, if the light modulation factor needs to be 100% to emphasize the quality of the transmission optical signal, the driving voltage at which the optical output is zero is set to V₀, the phase modulation amount φ is set to 2π, and the predetermined phase modulation amount is set to Δθ. If the light modulation factor needs to be 50% to emphasize reduction of the power consumption of the driving electric circuit of the phase modulation amount, the driving voltage at which the optical output is ½ is set to V₀, the phase modulation amount φ is set to π, and the predetermined phase modulation amount is set to Δθ. In this way, an arbitrary light modulation factor can be implemented in accordance with the required specifications.

In the Mach-Zehnder light modulator 12, an electrical signal of RZ code may be used as the electrical signal Sa, and the light multiplexing circuit 24 may output, as the output optical signal 36, double pulses having the same amplitude and opposite frequency chirp signs. Using the frequency chirp characteristic of the double pulses allows time multiplex or frequency multiplex by separating single pulses using a predetermined transmission optical filter.

In the Mach-Zehnder light modulator 12, the phase modulator 23 may include a plurality of phase modulating units, and the delay times of the phase modulating units may be set to different values within the range of time shorter than the transient response time of the phase modulator 22 or the rise and fall times of the first electrical signal. This makes it possible to optimally compensate for the rise and fall times of the electrical signal and the response characteristic of the phase modulator. Additionally, even when the rise and fall times of the electrical signal have a plurality of band limiting factors, each time can optimally be compensated for.

In the optical transmitter 10, a value larger than the Fourier transform value of the pulse width of the output optical signal 37 output from the optical filter 14 may be used as the frequency chirp amount of the output optical signal 36 output from the Mach-Zehnder light modulator 12. This enables to obtain the output optical signal 37 having a satisfactory waveform close to Fourier transform limit even when single optical pulses are separated from the double pulses using the optical filter 14.

In the optical transmitter 10, the optical filter 14 may have a bandpass transmission characteristic and use, as the center frequency, a value shifted from the frequency of the continuous optical signal from the laser source 11 to the high or low frequency side. When the optical filter 14 having the bandpass transmission characteristic and the center frequency shifted to the high or low frequency side is used, the output optical signal 37 formed from single optical pulses can be obtained from the output optical signal 36 with a frequency chirp.

In the optical transmitter 10, a transmission characteristic approximated by an nth-order (n is a positive number) Gaussian function may be used as the transmission characteristic of the optical filter 14. The Fourier-transformed spectrum of the Gaussian function represents the waveform of the Gaussian function. Hence, when an optical filter having the Gaussian transmission characteristic is used, the output optical signal 37 having a Gaussian waveform excellent in the transfer characteristic can be obtained.

In the optical transmitter 10, a value larger than the Fourier transform value of the optical pulse width of RZ code may be used as the transmission spectral bandwidth of the optical filter 14. This enables to obtain the high-quality output optical signal 37 without any increase in the pulse width without causing the optical filter 14 to remove the spectral component necessary for the output optical signal 37.

In this exemplary embodiment, the bit rate of the electrical signal is 25 Gbits/s. However, the present invention is not limited to this. The present invention is applicable to any arbitrary bit rate such as 10 Gbits/s or 40 Gbits/s to obtain the same functions and effects as described above. The phase modulation amount Δθ, delay time τ, and the transmission characteristic of the optical filter 14 can be optimized for the bit rate to be used or each of the electrical signal waveforms. If a predetermined phase shifter is inserted into one of the arms of the Mach-Zehnder light modulator 12, the DC bias of the electrical signal Sc can arbitrarily be set, and the phase modulator 23 can operate within the range of positive driving voltages.

### Second Exemplary Embodiment

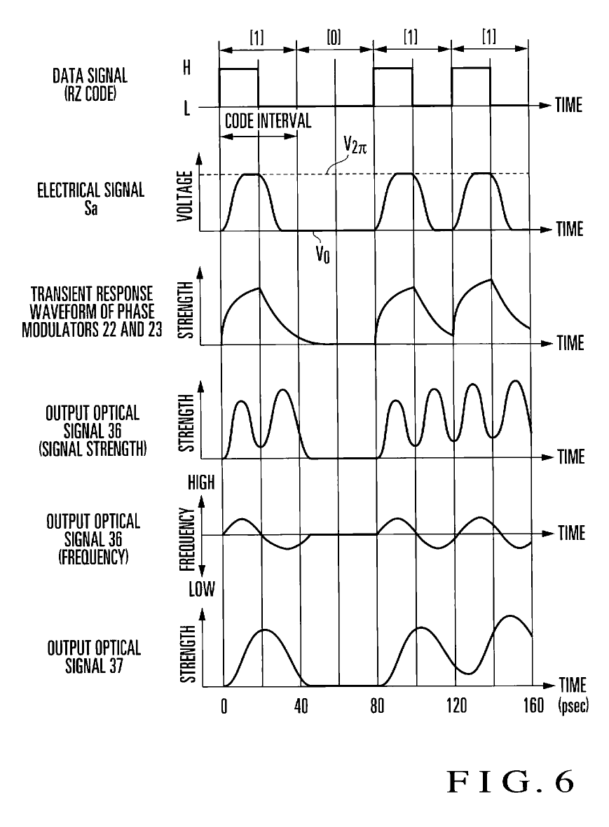

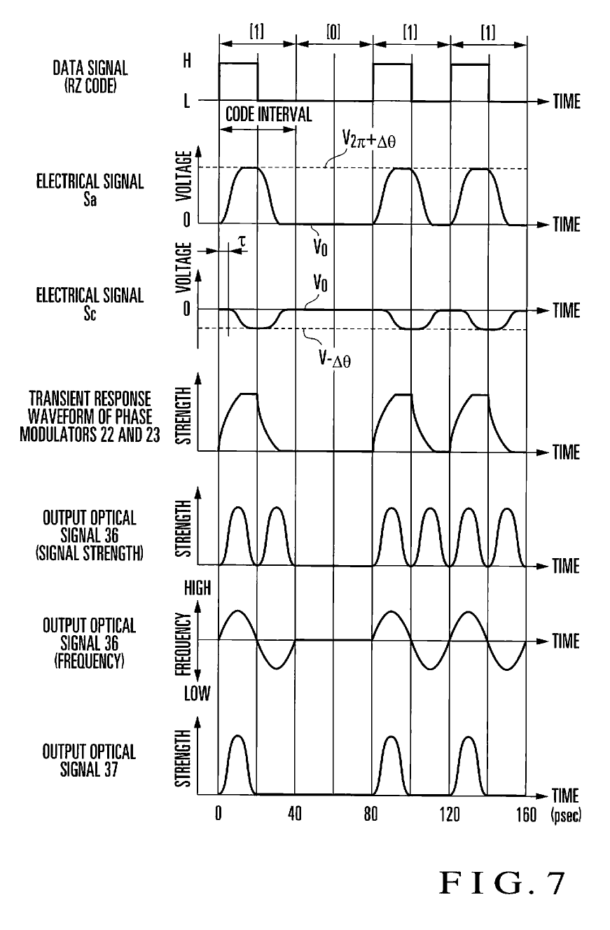

An optical transmitter according to the second exemplary embodiment of the present invention will be described next with reference to FIGS. 6 and 7. FIG. 6 is a timing chart of signal waveforms representing the operation of a conventional optical transmitter. FIG. 7 is a timing chart of signal waveforms representing the operation of the optical transmitter according to the second exemplary embodiment of the present invention.

In the first exemplary embodiment, an example has been explained in which the bit rate of the electrical signals Sa and Sc is 25 Gbits/s. In this exemplary embodiment, an example will be described in which the band is set to 10 GHz that is less than ½ of 25 Gbits/s. Ten GHz is the band of an existing light modulator using a ceramic, a silicon semiconductor, or a ceramic on a silicon substrate. The arrangement of this exemplary embodiment is the same as in the first exemplary embodiment except a phase modulation amount Δθ and a delay time τ, and a detailed description thereof will not be repeated.

[Conventional Phase Modulating Operation]

FIG. 6 shows the signal waveforms of the respective portions of the optical transmitter according to the related art, which are obtained when 2π phase modulation is performed using only a phase modulator 22 in FIG. 1. FIG. 6 shows the waveforms of electrical signals Sa and Sc corresponding to an RZ electrical signal having a “1011” pattern, the transient response waveform of an optical signal 34 of the phase modulator 22 for the rectangular electrical pulse, the waveform of an output optical signal 36 from a Mach-Zehnder light modulator 12, the frequency of the output optical signal 36 from the Mach-Zehnder light modulator 12, and the waveform of an output optical signal 37 from an optical filter 14.

In this case, the response characteristic, i.e., the rise and fall times of the phase modulator 22 are 35 psec. As is apparent from the fact that the transient response characteristic of the phase modulator 22 shown in FIG. 6 reaches the next code section, the band is short for the electrical signal of 25 Gbits/s.

Hence, double pulses output from the Mach-Zehnder light modulator 12 are not separated, and considerable intersymbol interference occurs. Additionally, the frequency chirp of the output optical signal from the Mach-Zehnder light modulator 12 has a small value that is ⅓ to ¼ or less of the Fourier transform value of the pulse width.

As can be seen from the waveform of the optical signal from the optical filter 14 in FIG. 6, the signal of 25 Gbits/s cannot be transmitted due to intersymbol interference.

[Phase Modulating Operation of this Exemplary Embodiment]

This exemplary embodiment is applicable to a phase modulator whose band is greatly short with respect to the bit rate, as described above. It is possible to obtain a satisfactory modulation waveform and frequency chirp characteristic by compensating for the band characteristic.

FIG. 7 shows the signal waveforms of the respective portions of the optical transmitter according to this exemplary embodiment, which are obtained when the phase modulation amount Δθ is 2π/3, and the delay time is 14 psec. FIG. 7 shows the waveforms of the electrical signals Sa and Sc corresponding to an RZ electrical signal having a “1011” pattern, the transient response waveform of an optical signal 35 of the entire phase modulators 22 and 23 for the driving electrical pulse, the waveform of the output optical signal 36 from the Mach-Zehnder light modulator 12, the frequency of the output optical signal 36 from the Mach-Zehnder light modulator 12, and the waveform of the output optical signal 37 from the optical filter 14.

As is apparent from FIG. 7, the phase modulators 22 and 23 having a two-stage operation driving arrangement improve the output waveform and the frequency chirp based on the same principle as in FIG. 2 described above. As can be seen from the waveform of the output optical signal 37 from the optical filter 14 in FIG. 7, a signal of 25 Gbits/s or a high-speed photoelectrical signal is obtained by time multiplex.

### Third Exemplary Embodiment

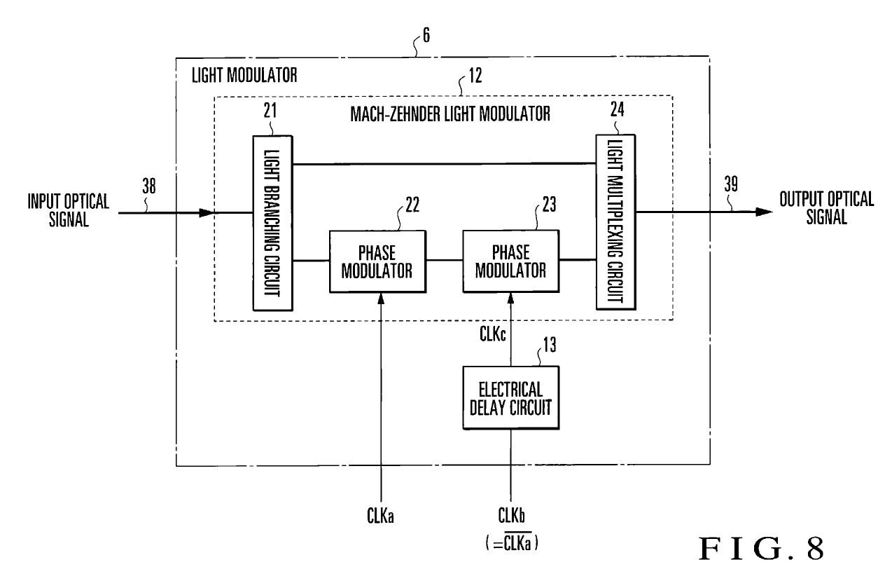

A light modulator according to the third exemplary embodiment of the present invention will be described next with reference to FIG. 8. FIG. 8 is a block diagram showing the arrangement of the light modulator according to the third exemplary embodiment of the present invention. In the first exemplary embodiment, an example has been explained in which the Mach-Zehnder light modulator 12 is applied to the optical transmitter 10. In the third exemplary embodiment, an example will be described in which a Mach-Zehnder light modulator 12 is applied to a light modulator 6.

The light modulator 6 includes the Mach-Zehnder light modulator 12 and an electrical delay circuit 13.

The Mach-Zehnder light modulator 12 includes a light modulating circuit using, e.g., an electrooptic effect, and has a function of modulating the strength and phase of an input optical signal 38 containing time-multiplexed optical pulses by a Mach-Zehnder light modulating method using an electrical signal CLKa and demultiplexing and outputting an output optical signal 39 containing an optical pulse at a time position synchronized with the electrical signal CLKa.

In this exemplary embodiment, the input optical signal 38 containing time-multiplexed optical pulses is input in place of the input optical signal 31 from the laser source 11 of the first exemplary embodiment, and the optical filter 14 for extracting one sideband of the output optical signal 37 from the Mach-Zehnder light modulator 12 is omitted, unlike the first exemplary embodiment.

Additionally, an electrical signal formed from a clock signal synchronized with a desired time position to be time-demultiplexed is used as an electrical signal Sa in place of the data signal of RZ code of the first exemplary embodiment.

The Mach-Zehnder light modulator 12 includes a light branching circuit 21, phase modulator (first phase modulator) 22, phase modulator (second phase modulator) 23, and light multiplexing circuit 24, like the first exemplary embodiment.

The remaining components such as a phase modulation amount φ+Δθ used by the phase modulator 22, a phase modulation amount −Δθ used by the phase modulator 23, and a delay time τ in the electrical delay circuit 13 are the same as in the first exemplary embodiment, and a detailed description thereof will not be repeated.

[Operation of Third Exemplary Embodiment]

In the first exemplary embodiment, the phase of the input optical signal 31 formed from a continuous laser beam is modulated at the rise and fall timings of the electrical signal Sa formed from a data signal, thereby obtaining an optical pulse corresponding to the electrical signal Sa. This phase modulating operation can be regarded as an operation of time-demultiplexing the input optical signal 31 formed from a continuous laser beam at the rise and fall timings of the electrical signal Sa to generate an optical pulse.

In this exemplary embodiment, in the above-described arrangement, the input optical signal 38 in which optical pulses are multiplexed is used in place of the input optical signal 31, and the electrical signal CLKa formed from a clock signal is used in place of the electrical signal Sa. This causes the Mach-Zehnder light modulator 12 to time-demultiplex the optical pulses of the input optical signal 38 at the rise and fall timings of the electrical signal CLKa and output them as the output optical signal 39.

As described above, in this exemplary embodiment, the light branching circuit 21 branches the input optical signal 38 in which a plurality of time channels are multiplexed into two optical signals. The phase modulator (first phase modulator) 22 modulates the phase of one of the optical signals based on the electrical signal CLKa. Then, the phase modulator (second phase modulator) 23 performs phase modulation in a smaller amount and opposite polarity as compared to the phase modulator 22 based on an electrical signal CLKc obtained by delaying an inverse logic signal CLKb of the electrical signal CLKa by the predetermined delay time τ shorter than the transient response time of the phase modulator 22 or the rise and fall times of the electrical signal CLKa. The light multiplexing circuit 24 multiplexes the optical signal obtained by the phase modulator 23 with the other optical signal of the input optical signal and outputs the output optical signal 39 which is obtained by demultiplexing, from the input optical signal 38, the optical pulse of the time channel synchronized with the electrical signal CLKa.

It is therefore possible to time-demultiplex, from a desired time position, an optical pulse having a satisfactory waveform which compensates for the rise and fall characteristics of the electrical signal and the transient response characteristic of the phase modulators without any intersymbol interference using an existing light modulator having not so high operation speed. This allows to time-demultiplex the optical pulse of an arbitrary time channel from a high-capacity high-speed photoelectrical signal that is bit-interleaved at a high rate.

### Fourth Exemplary Embodiment

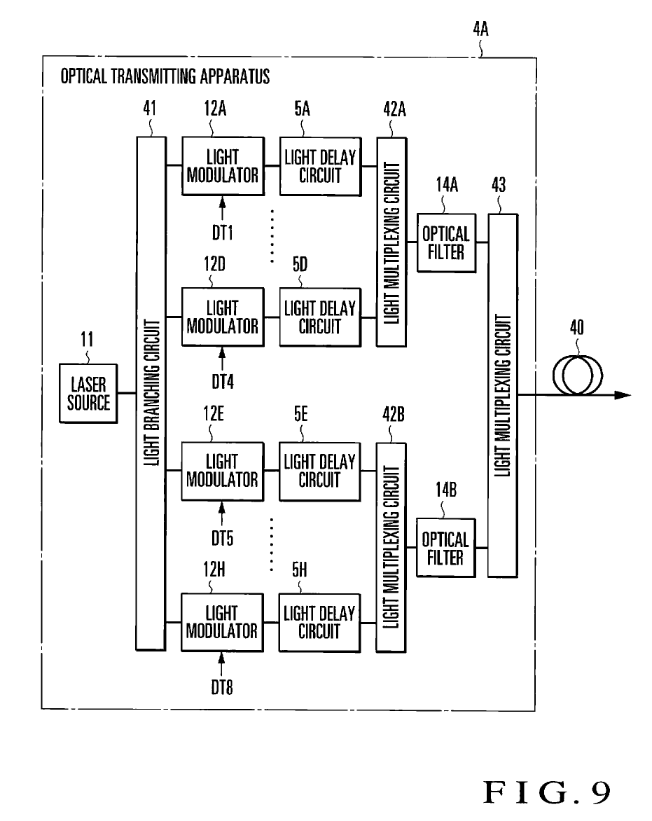

An optical transmitting apparatus according to the fourth exemplary embodiment of the present invention will be described next with reference to FIG. 9. FIG. 9 is a block diagram showing the arrangement of the optical transmitting apparatus according to the fourth exemplary embodiment of the present invention.

In this exemplary embodiment, an optical transmitting apparatus will be explained, which performs time multiplex or frequency multiplex of a plurality of electrical signals using the output optical signal from a Mach-Zehnder light modulator 12 and an optical filter 14 described in the first or second exemplary embodiment. An example will be described here, in which electrical signals of eight different channels are multiplexed, the bit rate of an electrical signal is 25 Gbits/s, and the band of phase modulators 22 and 23 is 25 GHz.

In an optical transmitting apparatus 4A shown in FIG. 9, a light branching circuit 41 branches the input optical signal from a laser source 11 into eight optical signals. The optical signals are input to Mach-Zehnder light modulators 12A to 12H, respectively. The Mach-Zehnder light modulators 12A to 12H correspond to transmission channels 1 to 8, respectively, and encode the input optical signal based on electrical signals S1 to S8 corresponding to the transmission channels. The arrangement of each of the Mach-Zehnder light modulators 12A to 12H is the same as that of the Mach-Zehnder light modulator 12 described in the first exemplary embodiment.

Each of transmission channels 1 to 4 uses, of double optical pulses output from a corresponding Mach-Zehnder light modulator, a sideband component chirped to the high frequency side. In transmission channels 1 to 4, the optical signals from the Mach-Zehnder light modulators 12A to 12D are time-multiplexed by light delay circuits 5A to 5D and a light multiplexing circuit 42A using bit interleaving, and an optical filter 14A extracts the sideband component chirped to the high frequency side. The arrangement of the optical filter 14A is the same as that of the optical filter 14 described in the first exemplary embodiment.

Each of transmission channels 5 to 8 uses, of double optical pulses output from a corresponding Mach-Zehnder light modulator, a sideband component chirped to the low frequency side. In transmission channels 5 to 8, the optical signals from the Mach-Zehnder light modulators 12E to 12H are time-multiplexed by light delay circuits 5E to 5H and a light multiplexing circuit 42B using bit interleaving, and an optical filter 14B extracts the sideband component chirped to the low frequency side. The arrangement of the optical filter 14B is also the same as that of the optical filter 14 described in the first exemplary embodiment. Note that the center frequency of the optical filter 14B shifts from the frequency of the laser source 11 to the low frequency side by 100 GHz.

Then, the optical signals of transmission channels 1 to 8 output from the optical filters 14A and 14B are frequency-multiplexed by a light multiplexing circuit 43 and transmitted to the receiving side through an optical fiber 40.

As described above, in this exemplary embodiment, the light branching circuit 41 branches the input optical signal from the laser source 11 into time channels. The Mach-Zehnder light modulators 12A to 12H according to the first exemplary embodiment modulate the phases of the branched optical signals based on the electrical signals S1 to S8 corresponding to the time channels, respectively. The light delay circuits 5A to 5H delay the optical signals by times corresponding to the time channels. The light multiplexing circuits 42A and 42B multiplex the optical signals for each frequency channel. The optical filters 14A and 14B extract the sideband components on the high and low frequency sides of the output optical signal. The light multiplexing circuit 43 multiplexes the sideband components.

This implements high-capacity high-speed transmission at 200 Gbits/s using one light source having one wavelength by combining time multiplex of four channels and frequency multiplex of two channels even when the band of a phase modulator is 25 GHz. It is also possible to suppress the penalty of the receiving level caused by intersymbol interference and beat noise generated upon multiplex to about 1 to 2 dB.

In this exemplary embodiment, an example has been described in which after the light multiplexing circuits 42A and 42B multiplex the optical signals of time channels for each frequency channel, each of the optical filters 14A and 14B extracts one sideband component, as shown in FIG. 9. However, the present invention is not limited to this.

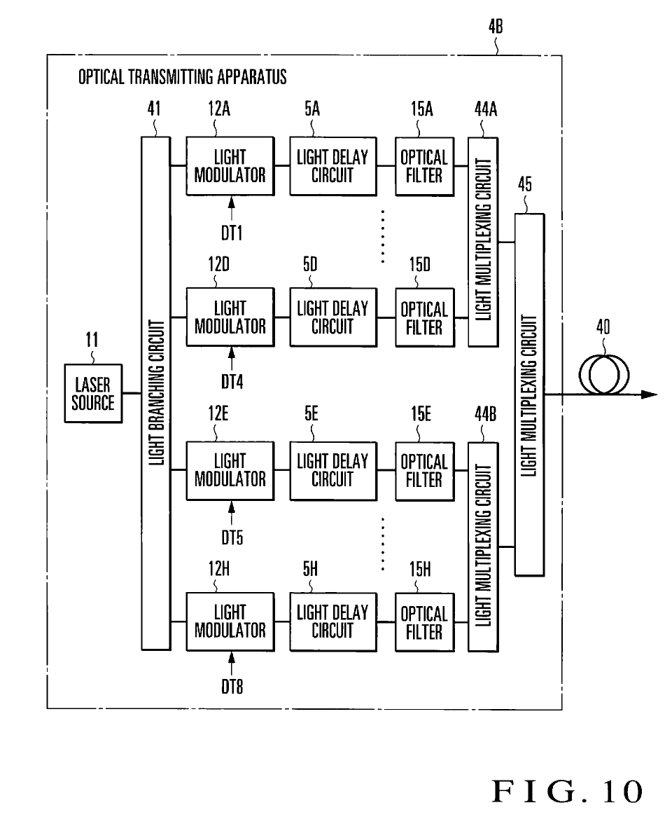

FIG. 10 is a block diagram showing the arrangement of another optical transmitting apparatus according to the fourth exemplary embodiment of the present invention. In an optical transmitting apparatus 4B, optical filters 15A to 15H are provided in correspondence with the time channels on the output side of the light delay circuits 5A to 5D of the respective time channels. Each of light multiplexing circuits 44A and 44B multiplexes the optical signals from the optical filters 15A to 15H, i.e., the optical signals of the time channels for each frequency channel.

The arrangement for causing the optical filters 15A to 15H to extract the sideband components before multiplex by the light multiplexing circuits 44A and 44B makes it possible to reduce the interference effect of spectral components near the frequency of the laser source 11 and decrease the frequency chirp amounts given by the light modulators 12A to 12H.

### Fifth Exemplary Embodiment

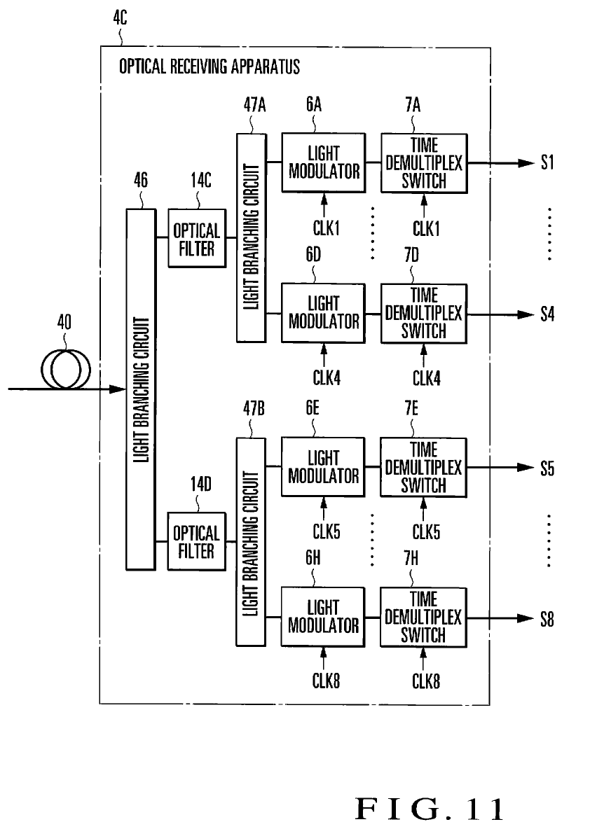

An optical receiving apparatus according to the fifth exemplary embodiment of the present invention will be described next with reference to FIG. 11. FIG. 11 is a block diagram showing the arrangement of the optical receiving apparatus according to the fifth exemplary embodiment of the present invention.

In this exemplary embodiment, an optical receiving apparatus will be explained, which outputs, using a Mach-Zehnder light modulator 12 described in the first or second exemplary embodiment, original electrical signals from a received optical signal in which a plurality of electrical signals are time-multiplexed or frequency-multiplexed. An example will be described here, in which electrical signals of eight different channels are multiplexed, the bit rate of an electrical signal is 25 Gbits/s, and the band of phase modulators 22 and 23 is 25 GHz.

In an optical receiving apparatus 4C shown in FIG. 11, a received optical signal from an optical fiber 40 is frequency-demultiplexed by a light branching circuit 46 and optical filters 14C and 14D. Then, light branching circuits 47A and 47B branch the optical signals into those of the respective reception channels. In reception channels 1 to 8, light modulators 6A to 6H and time demultiplex switches 7A to 7H time-demultiplex the optical signals branched by the light branching circuits 47A and 47B, thereby reproducing electrical signals S1 to S8 of reception channels 1 to 8.

The light modulators 6A to 6H are time demultiplex switches each of which extracts a 2-bit time multiplex signal from a 4-bit time multiplex signal and requires a high-speed switch characteristic. In this exemplary embodiment, the above-described light modulator 6 shown in FIG. 8 according to the third exemplary embodiment is used as each of the light modulators 6A to 6H. In this case, clock signals CLK1 to CLK8 each of which is formed from an electrical pulse corresponding to the time position of a time channel are used as the electrical signals CLKa to be input to the light modulators 6A to 6H.

As the time demultiplex switches 7A to 7H, common time demultiplex switches having a function of switching received optical signals based on the electrical signals CLK1 to CLK8 are used.

As described above, in this exemplary embodiment, after the light branching circuit 46 branches the input optical signal into two optical signals, the optical filters 14C and 14D generate the optical signals of the respective frequency channels by extracting the sideband components on the high and low frequency sides. The light branching circuits 47A and 47B branch the optical signals into signals of time channels. The Mach-Zehnder light modulators 6A to 6H according to the first exemplary embodiment time-demultiplex, from the branched optical signals, double optical pulses containing the time channels based on the electrical signals CLK1 to CLK8 synchronized with the respective time channels. Each of the time demultiplex switches 7A to 7H extracts an optical signal formed from only an optical pulse of a corresponding time channel.

This implements high-capacity high-speed transmission at 200 Gbits/s using one light source having one wavelength by combining time multiplex of four channels and frequency multiplex of two channels even when the band of a phase modulator is 25 GHz. It is also possible to suppress the penalty of the receiving level caused by intersymbol interference and beat noise generated upon multiplex to about 1 to 2 dB.

In this exemplary embodiment, an example has been described in which the light branching circuits 47A and 47B branch the optical signals of the respective frequency channels from the optical filters 14C and 14D into the optical signals of the time channels. However, the light branching circuits 47A and 47B may be omitted depending on the multiplex method used for the received optical signal or the optical pulse time demultiplex method. In this case, for example, the light modulators 6A to 6H and the time demultiplex switches 7A to 7H are used to time-demultiplex the optical pulses of the communication channels from the optical signals from the optical filters 14C and 14D.

In this exemplary embodiment, a Mach-Zehnder type or directional coupler type optical path switching light modulator (optical switch) may be used as each of the time demultiplex switches 7A to 7H. When optical pulses of two time channels are demultiplexed by one light modulator, the number of the time demultiplex switches 7A to 7H can be reduced to ½ of the number of reception channels. This contributes to cost reduction of the optical receiving apparatus.

In this exemplary embodiment, an example has been described in which the light modulators 6A to 6H and the time demultiplex switches 7A to 7H provided for the respective time channels time-demultiplex the optical pulses of the time channels, as shown in FIG. 11. However, the present invention is not limited to this.

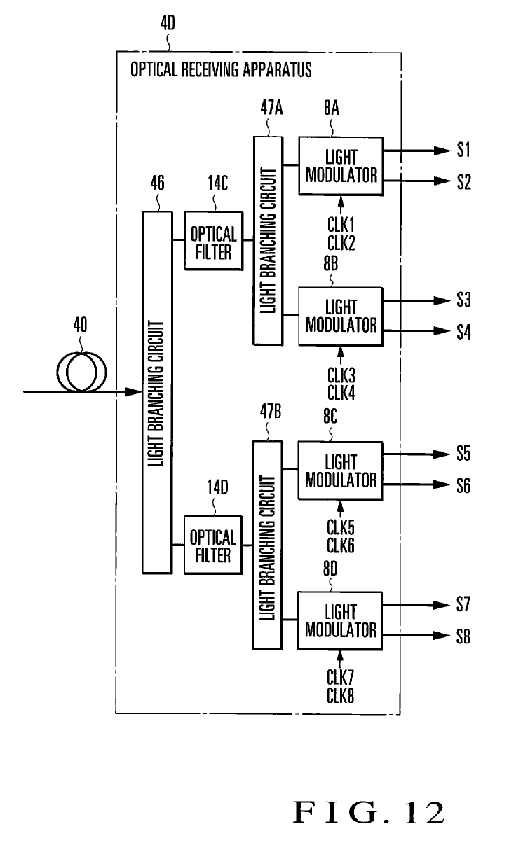

FIG. 12 is a block diagram showing the arrangement of another optical receiving apparatus according to the fifth exemplary embodiment of the present invention. In an optical receiving apparatus 4D, Mach-Zehnder type or directional coupler type optical path switching light modulators (optical switches) 8A to 8D each corresponding to two time channels are provided on the output side of the light branching circuits 47A and 47B of the frequency channels. The light modulators 8A to 8D time-demultiplex the optical pulses of the time channels based on the electrical signals CLK1 to CLK8 formed from clock signals synchronized with the time switches. This makes it possible to decrease the light modulators 6A to 6H and the time demultiplex switches 7A to 7H to the light modulators 8A to 8D whose number is ½ of the number of reception channels and contribute to cost reduction and downsizing of the optical receiving apparatus.

In this exemplary embodiment, a phase modulator having a band of only ½ the bit rate as described in the second exemplary embodiment may be used as the light modulators 6A to 6H. When the band of the phase modulator is 10 GHz, only two channels can be time-multiplexed, as is apparent from FIG. 7 described above. However, when frequency multiplex of two channels is combined, transmission of 100 Gbits/s using one wavelength, i.e., high-capacity high-speed optical transmission 10 times larger than the band of the phase modulator can be implemented.

Differential driving type Mach-Zehnder light modulators may be used as the light modulators 8A to 8D, and their phase modulation amount may be larger than the phase modulation amount corresponding to a desired light intensity. Normally, if a light modulator having not so high operation speed is driven at a high bit rate, the transient response characteristic of the phase modulator reaches the next code section. However, a light modulator serving as a time demultiplex switch in an optical receiving apparatus is driven by a clock signal having a fixed pattern, and therefore, no pattern effect appears. When such a phase modulator uses a phase modulation amount larger than the phase modulation amount corresponding to a desired light intensity, the phase modulation waveform of the phase modulator steeply changes, like the above-described principle of the phase modulating method of the present invention (FIG. 2). It is therefore possible to use a light modulator having not so high operation speed as a time demultiplex switch in an optical receiving apparatus for performing high-capacity high-speed optical transmission and contribute to cost reduction of the optical transmitting apparatus.

1-22. (canceled)

23. An optical transmitting apparatus comprising:
a laser source which outputs a continuous optical signal;
a light branching circuit which branches the continuous optical signal into 2×m (m is a positive number) communication channels in which m time channels and two frequency channels are multiplexed;
Mach-Zehnder light modulators which are provided for the respective communication channels and modulate phases of optical signals from said light branching circuit based on electrical signals;
light delay circuits which are provided for the respective communication channels and delay output optical signals from said Mach-Zehnder light modulators of the communication channels by times corresponding to the time channels of the communication channels, respectively;
a first light multiplexing circuit which is provided in correspondence with one frequency channel and multiplexes output optical signals from said light delay circuits of m communication channels belonging to the frequency channel;
a second light multiplexing circuit which is provided in correspondence with the other frequency channel and multiplexes output optical signals from said light delay circuits of m communication channels belonging to the frequency channel;
a first optical filter which extracts a sideband component on a high frequency side of an output optical signal from said first light multiplexing circuit;
a second optical filter which extracts a sideband component on a low frequency side of an output optical signal from said second light multiplexing circuit; and
a light multiplexing circuit which multiplexes output optical signals from said first optical filter and said second optical filter,
said Mach-Zehnder light modulator comprising:
a light branching circuit which branches an input optical signal into two optical signals;
a first phase modulator which modulates a phase of one of the optical signals branched by said light branching circuit based on a first electrical signal, and outputs the optical signal;
a second phase modulator which modulates the phase of the optical signal from said first phase modulator in a smaller amount and opposite polarity as compared to said first phase modulator based on a second electrical signal obtained by delaying an inverse logic signal of the first electrical signal by a predetermined delay time shorter than a transient response time of said first phase modulator or rise and fall times of the first electrical signal, and outputs the optical signal; and
a light multiplexing circuit which multiplexes the other optical signal branched by said light branching circuit with the optical signal from said second phase modulator, and outputs a pulse-like output optical signal.

24. An optical transmitting apparatus comprising:
a laser source which outputs a continuous optical signal;
a light branching circuit which branches the continuous optical signal into 2×m (m is a positive number) communication channels in which m time channels and two frequency channels are multiplexed;
Mach-Zehnder light modulators which are provided for the respective communication channels and modulate phases of optical signals from said light branching circuit based on electrical signals;
light delay circuits which are provided for the respective communication channels and delay output optical signals from said Mach-Zehnder light modulators of the communication channels by times corresponding to the time channels of the communication channels, respectively;
first optical filters which are provided for m communication channels belonging to one frequency channel, respectively, and extract sideband components on a high frequency side of output optical signals from said light delay circuits of the communication channels;
second optical filters which are provided for m communication channels belonging to the other frequency channel, respectively, and extract sideband components on a low frequency side of output optical signals from said light delay circuits of the communication channels;
a first light multiplexing circuit which is provided in correspondence with one frequency channel and multiplexes output optical signals from m first optical filter belonging to the frequency channel;
a second light multiplexing circuit which is provided in correspondence with the other frequency channel and multiplexes output optical signals from m second optical filter belonging to the frequency channel; and
a light multiplexing circuit which multiplexes output optical signals from said first light multiplexing circuit and said second light multiplexing circuit,
said Mach-Zehnder light modulator comprising:
a light branching circuit which branches an input optical signal into two optical signals;
a first phase modulator which modulates a phase of one of the optical signals branched by said light branching circuit based on a first electrical signal, and outputs the optical signal;
a second phase modulator which modulates the phase of the optical signal from said first phase modulator in a smaller amount and opposite polarity as compared to said first phase modulator based on a second electrical signal obtained by delaying an inverse logic signal of the first electrical signal by a predetermined delay time shorter than a transient response time of said first phase modulator or rise and fall times of the first electrical signal, and outputs the optical signal; and
a light multiplexing circuit which multiplexes the other optical signal branched by said light branching circuit with the optical signal from said second phase modulator, and outputs a pulse-like output optical signal.

25. An optical transmitting apparatus according to claim 23, wherein an average of a phase modulation amount of said first phase modulator and that of said second phase modulator equals a phase modulation amount to obtain a desired light intensity in the output optical signal.

26. An optical transmitting apparatus according to claim 23, wherein
a phase modulation amount of said first phase modulator is a sum of a phase modulation amount φ to obtain a desired light modulation factor in the output optical signal and a predetermined phase compensation amount Δθ to compensate for the transient response time of said first phase modulator or the rise and fall times of the first electrical signal, and
a phase modulation amount of said second phase modulator is a phase compensation amount −Δθ.

27. An optical transmitting apparatus according to claim 23, wherein
the first electrical signal is an electrical signal of RZ code, and
said light multiplexing circuit outputs, as the output optical signal, double pulses having the same amplitude and opposite frequency chirp signs.

28. An optical transmitting apparatus according to claim 23, wherein said second phase modulator includes a plurality of phase modulating units, and time delays of said phase modulating units are different from each other within a range of time shorter than the transient response time of said first phase modulator or the rise and fall times of the first electrical signal.

29. An optical transmitting apparatus according to claim 23, wherein
the input optical signal is an optical signal in which a plurality of time channels are multiplexed,
the first electrical signal is a clock signal having a predetermined period, and
said light multiplexing circuit demultiplexes an optical pulse of the time channel synchronized with the clock signal from the input optical signal, and outputs the optical pulse as the output optical signal.
